(19) United States
(12) Patent Application Publication
(10) Pub. No.: US 2022/0075962 A1
(43) Pub. Date: Mar. 10, 2022

(54) APPARATUS, SYSTEMS, METHODS AND STORAGE MEDIA FOR GENERATING LANGUAGE

(71) Applicant: Patent Theory LLC, Sheridan, WY (US)

(72) Inventors: Lukás Kovarík, Prague-Vrsovice (CZ); Dominik Pavlov, Pezinok (SK)

(73) Assignee: Patent Theory LLC, Sheridan, WY (US)

(21) Appl. No.: 17/467,741

(22) Filed: Sep. 7, 2021

Related U.S. Application Data
(60) Provisional application No. 63/074,818, filed on Sep. 4, 2020.

(51) Int. Cl. G06F 40/56; G06F 40/186; G06F 16/35

(52) U.S. Cl. CPC G06F 40/56; G06F 16/353; G06F 40/186

(57) ABSTRACT

Apparatus, systems, methods and storage media for generating patent language are disclosed. Some embodiments may include receiving input text including patent claim language, identify one or more portions of the input text, classify the one or more identified portions, assigning the one or more identified portions to one or more associated fields of an output template based on the classification, generate output text based on the assignment of the one or more identified portions to the one or more associated fields of the output template.

### FIELD OF THE DISCLOSURE

The present disclosure relates to Apparatus, systems, methods and storage media for generating language.

### SUMMARY

One aspect of the present disclosure relates to an apparatus for generating patent language. The apparatus may include at least one memory storing computer program instructions and at least one processor configured to execute the computer program instructions to cause the apparatus at least to carry out operations. In some embodiments the instructions, when executed, may cause the apparatus to receive input text including patent claim language. In some embodiments the instructions, when executed, may cause the apparatus to identify one or more portions of the input text. In some embodiments the instructions, when executed, may cause the apparatus to classify the one or more identified portions. In some embodiments the instructions, when executed, may cause the apparatus to assign the one or more identified portions to one or more associated fields of an output template based on the classification. In some embodiments the instructions, when executed, may cause the apparatus to generate output text based on the assignment of the one or more identified portions to the one or more associated fields of the output template. In some cases, the generation of output text includes identifying parts of speech and the classified one or more portions to translate the patent claim language to natural language prose associated with portions of a patent document other than the patent claim language.

In some cases, the classifying is based on identifying one or more of a preamble, one or more patent purpose clauses, a claim type identifier, one or more claim element clauses, and one or more definition clauses and the one or more definition clauses further define a concept associated with the claim element clauses.

In some cases, the instructions, when executed, may cause the apparatus to generate one or more figures associated with the output text. In some cases, generating the one or more figures includes detecting one or more claim element clauses from the input text, generating one or more visual elements based on one or more detected claim element clauses within the one or more identified portions of the input text, wherein each of the one or more visual elements generated is associated with a different claim element clause, generating figure-specific output text based on the detected one or more claim element clauses, and inserting the figure-specific output text associated with the detected one or more claim element clauses in one or more associated visual elements from among the one or more generated visual elements. In some cases, the instructions, when executed, may cause the apparatus to number the one or more generated visual elements based on a position of each of the associated claim element clauses within the input text.

In some cases, generating output text includes submitting the input text to natural language models, wherein the natural language models are based on patent document constraints.

In some cases, the instructions, when executed, may cause the apparatus to map a word or phrase within the input text to an element within a figure based on user input, wherein generating output text is based on the mapping and number the element based on a position of the word or phrase within the input text and in comparison, to subsequent and previously mapped words or phrases.

In some cases, the instructions, when executed, may cause the apparatus to receive a selection of one or more claim types and translate the input text into one or more selected claim types. In some cases, the output text is dynamically generated while the input text is received.

In some cases, the instructions, when executed, may cause the apparatus to generate the input text based on technical input documents describing a technical concept and generate the input text by replacing the associated one or more words of the technical input document with the one or more identified hypernyms.

In some cases, classifying includes identifying a numerical range within the input text, and generating the output includes expressing the numerical range as a plurality of ranges having a smaller scale compared to the identified numerical range based on step size.

In some cases, the instructions, when executed, may cause the apparatus to generate one or more mirrored claims from the input text.

Another aspect of the present disclosure relates to a system configured for generating patent language. The system may include one or more hardware processors configured by machine-readable instructions. The instructions may be configured to receive input text including patent claim language. The instructions may be configured to identify one or more portions of the input text. The instructions may be configured to classify the one or more identified portions. The instructions may be configured to assign the one or more identified portions to one or more associated fields of an output template based on the classification. The instructions may be configured to generate output text based on the assignment of the one or more identified portions to the one or more associated fields of the output template. In some cases, the generation of output text includes identifying parts of speech and the classified one or more portions to translate the patent claim language to natural language prose associated with portions of a patent document other than the patent claim language.

In some cases, the classifying is based on identifying one or more of a preamble, one or more patent purpose clauses, a claim type identifier, one or more claim element clauses, and one or more definition clauses and the one or more definition clauses further define a concept associated with the claim element clauses.

In some cases, the one or more hardware processors may be further configured by machine-readable instructions to generate one or more figures associated with the output text. In some cases, generating the one or more figures includes detecting one or more claim element clauses from the input text, generating one or more visual elements based on one or more detected claim element clauses within the one or more identified portions of the input text, wherein each of the one or more visual elements generated is associated with a different claim element clause, generating figure-specific output text based on the detected one or more claim element clauses, and inserting the figure-specific output text associated with the detected one or more claim element clauses in one or more associated visual elements from among the one or more generated visual elements. In some cases, the one or more hardware processors may be further configured by machine-readable instructions to number the one or more generated visual elements based on a position of each of the associated claim element clauses within the input text.

In some cases, generating output text includes submitting the input text to natural language models, wherein the natural language models are based on patent document constraints.

In some cases, the one or more hardware processors may be further configured by machine-readable instructions to map a word or phrase within the input text to an element within a figure based on user input, wherein generating output text is based on the mapping and number the element based on a position of the word or phrase within the input text and in comparison, to subsequent and previously mapped words or phrases.

In some cases, the one or more hardware processors may be further configured by machine-readable instructions to receive a selection of one or more claim types and translate the input text into one or more selected claim types.

In some cases, the output text is dynamically generated while the input text is received.

In some cases, the one or more hardware processors may be further configured by machine-readable instructions to generate the input text based on technical input documents describing a technical concept and generate the input text by replacing the associated one or more words of the technical input document with the one or more identified hypernyms.

In some cases, classifying includes identifying a numerical range within the input text, and wherein generating the output includes expressing the numerical range as a plurality of ranges having a smaller scale compared to the identified numerical range based on step size.

In some cases, the one or more hardware processors may be further configured by machine-readable instructions to generate one or more mirrored claims from the input text.

Another aspect of the present disclosure relates to a method for generating patent language. The method may include receiving input text including patent claim language. The method may include identifying one or more portions of the input text. The method may include classifying the one or more identified portions. The method may include assigning the one or more identified portions to one or more associated fields of an output template based on the classification. The method may include generating output text based on the assignment of the one or more identified portions to the one or more associated fields of the output template. In some cases, the generation of output text includes identifying parts of speech and the classified one or more portions to translate the patent claim language to natural language prose associated with portions of a patent document other than the patent claim language.

In some cases, the classifying is based on identifying one or more of a preamble, one or more patent purpose clauses, a claim type identifier, one or more claim element clauses, and one or more definition clauses and the one or more definition clauses further define a concept associated with the claim element clauses.

In some cases, the method may further include generating one or more figures associated with the output text. In some cases, generating the one or more figures includes detecting one or more claim element clauses from the input text, generating one or more visual elements based on one or more detected claim element clauses within the one or more identified portions of the input text, wherein each of the one or more visual elements generated is associated with a different claim element clause, generating figure-specific output text based on the detected one or more claim element clauses, and inserting the figure-specific output text associated with the detected one or more claim element clauses in one or more associated visual elements from among the one or more generated visual elements. In some cases, the method may further include numbering the one or more generated visual elements based on a position of each of the associated claim element clauses within the input text.

In some cases, generating output text includes submitting the input text to natural language models, wherein the natural language models are based on patent document constraints.

In some cases, the method may further include mapping a word or phrase within the input text to an element within a figure based on user input, wherein generating output text is based on the mapping and numbering the element based on a position of the word or phrase within the input text and in comparison, to subsequent and previously mapped words or phrases.

In some cases, the method may further include receiving a selection of one or more claim types and translating the input text into one or more selected claim types.

In some cases, the output text is dynamically generated while the input text is received.

In some cases, the method may further include generating the input text based on technical input documents describing a technical concept and generating the input text by replacing the associated one or more words of the technical input document with the one or more identified hypernyms.

In some cases, classifying includes identifying a numerical range within the input text, and wherein generating the output includes expressing the numerical range as a plurality of ranges having a smaller scale compared to the identified numerical range based on step size.

In some cases, the method may further include generating one or more mirrored claims from the input text.

Another aspect of the present disclosure relates to a non-transient computer-readable storage medium for generating patent language. The computer readable storage medium may include instructions being executable by one or more processors to perform a method. The method may include receiving input text including patent claim language. The method may include identifying one or more portions of the input text. The method may include classifying the one or more identified portions. The method may include assigning the one or more identified portions to one or more associated fields of an output template based on the classification. The method may include generating output text based on the assignment of the one or more identified portions to the one or more associated fields of the output template. In some cases, the generation of output text includes identifying parts of speech and the classified one or more portions to translate the patent claim language to natural language prose associated with portions of a patent document other than the patent claim language.

In some cases, the classifying is based on identifying one or more of a preamble, one or more patent purpose clauses, a claim type identifier, one or more claim element clauses, and one or more definition clauses and the one or more definition clauses further define a concept associated with the claim element clauses.

In some cases, the method may further include generating one or more figures associated with the output text. In some cases, generating the one or more figures includes detecting one or more claim element clauses from the input text, generating one or more visual elements based on one or more detected claim element clauses within the one or more identified portions of the input text, wherein each of the one or more visual elements generated is associated with a different claim element clause, generating figure-specific output text based on the detected one or more claim element clauses, and inserting the figure-specific output text associated with the detected one or more claim element clauses in one or more associated visual elements from among the one or more generated visual elements. In some cases, the method may further include numbering the one or more generated visual elements based on a position of each of the associated claim element clauses within the input text.

In some cases, generating output text includes submitting the input text to natural language models, wherein the natural language models are based on patent document constraints.

In some cases, the method may further include mapping a word or phrase within the input text to an element within a figure based on user input, wherein generating output text is based on the mapping and numbering the element based on a position of the word or phrase within the input text and in comparison, to subsequent and previously mapped words or phrases.

In some cases, the method may further include receiving a selection of one or more claim types and translating the input text into one or more selected claim types.

In some cases, the output text is dynamically generated while the input text is received.

In some cases, the method may further include generating the input text based on technical input documents describing a technical concept and generating the input text by replacing the associated one or more words of the technical input document with the one or more identified hypernyms.

In some cases, classifying includes identifying a numerical range within the input text, and wherein generating the output includes expressing the numerical range as a plurality of ranges having a smaller scale compared to the identified numerical range based on step size.

In some cases, the method may further include generating one or more mirrored claims from the input text.

### BRIEF DESCRIPTION OF THE DRAWINGS

FIG. 1 illustrates a system configured for generating patent language.

FIGS. 2A, 2B, 2C, 2D, 2E, 2F, 2G, 2H and/or 2I illustrates a method for generating patent language.

### DETAILED DESCRIPTION

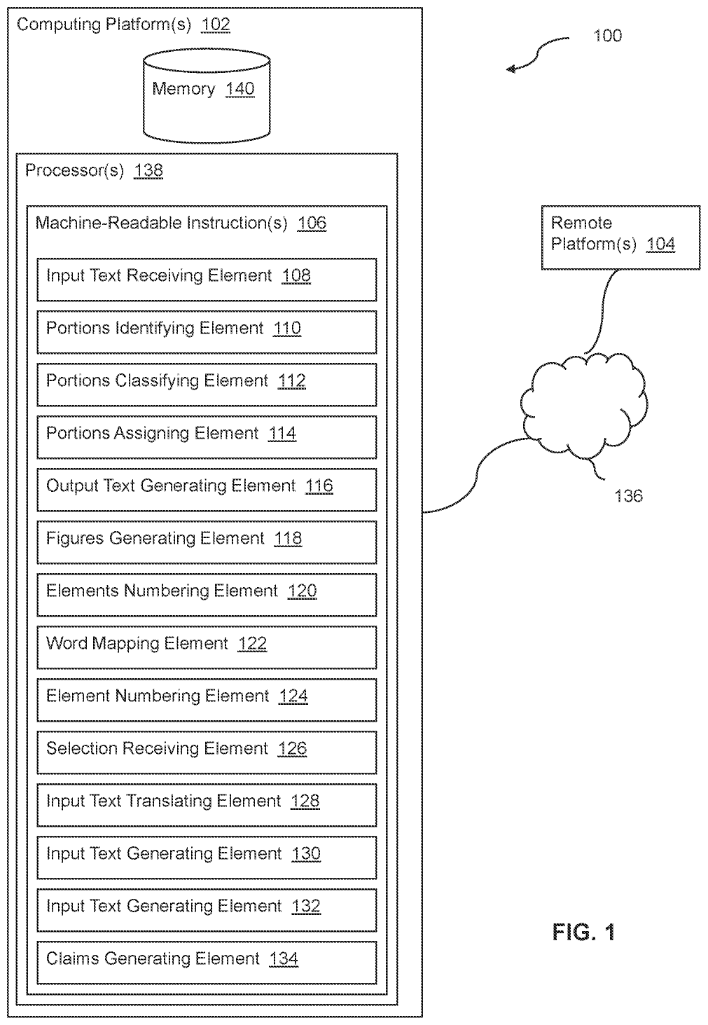

FIG. 1 illustrates a system 100 configured for generating patent language, in accordance with one or more embodiments. In some cases, system 100 may include one or more computing platforms 102. The one or more remote computing platforms 102 may be communicably coupled with one or more remote platforms 104. In some cases, users may access the system 100 via remote platform(s) 104.

The one or more computing platforms 102 may be configured by machine-readable instructions 106. Machine-readable instructions 106 may include modules. The modules may be implemented as one or more of functional logic, hardware logic, electronic circuitry, software modules, and the like. The modules may include one or more of input text receiving module 108, portions identifying module 110, portions classifying module 112, portions assigning module 114, output text generating module 116, figures generating module 118, elements numbering module 120, word mapping module 122, element numbering module 124, selection receiving module 126, input text translating module 128, input text generating module 130, input text generating module 132, claims generating module 134, and/or other modules.

Input text receiving module 108 may be configured to receive input text including patent claim language. In some cases, the input text may be received via a user-interface of a computing device. In some cases, the input text is received in a hypertext field associated with a website. Patent claim language may be considered language that is specific to a patent application's claims. Patent claim language may be configured to have one or more unique characteristics that differentiate patent claim language from natural language prose that may appear in other sections of a patent application. For example, patent claim language may have a different format that natural language prose, use different words than natural language prose, may include different punctuation and the like. Therefore, the system 100 described herein is configured to detect different characteristics of the patent claim language in the input text and use those identified characteristics to translate the input text into output text that resembles natural language prose found in other sections of a patent application. As drafting patent applications is tedious and can take a high level of attention to detail, the system 100 is configured to provide an increase in efficiency with use of the computing device as patent claim language, including various characteristics and portions of the patent claim language, can be used to automatically generate portions of other sections of the patent application other than the patent claims. Further, the system 100 will generate figures that are synchronized with the output text. By generating synchronized figures and output text user error may also be reduced as the system 100 will automatically generate synchronized numbering of various elements within the figures and use that numbering in the generated output text. By way of this synchronization, numbering errors that may otherwise exist due to human error are reduced, thereby further increasing the efficiency of use of a computing device. For example, a user may typically use a word processor to draft patent applications and may provide literal support for their claims in portions of the patent application other than the patent claims. However, providing literal support involves accurately reciting the claimed language in natural language prose, accurately and consistent numbering of both elements of the figures and the related output text, and consistently naming of elements in the figures as well as the output text. By contrast, the system 100 is configured to create output text for portions of a patent application other than the patent claims by one or more methods described herein. The system 100 may also be configured to generate output text including patent claim language based on mirroring the input text containing patent claim language into one or more different claim types, as described in more detail below.

Portions identifying module 110 may be configured to identify one or more portions of the input text. Portions classifying module 112 may be configured to classify the one or more identified portions. In some cases, the classifying performed by the portions classifying module is based on identifying one or more of a preamble, one or more patent purpose clauses, a claim type identifier, one or more claim element clauses, and one or more definition clauses and the one or more definition clauses further define a concept associated with the claim element clauses. In some cases, the one or more definition clauses further define a concept associated with the claim element clauses. The one or more definitions clauses may be defined herein as clauses, such as “wherein” clauses, that further define a concept associated with the claim element clauses based on detection of the use of the word “wherein.”

In some cases, the classifying may be configured to include identifying a numerical range within the input text, and wherein generating the output includes expressing the numerical range as a plurality of ranges having a smaller scale compared to the identified numerical range based on step size. For example, the input text may include “the anticaking agent including 15-30 wt. % reducing sugar.” This may be classified as a numerical range associated with a given element, in this case “reducing sugar.” The system 100, such as via the portions classifying element 112, may be configured to classify the “comprising 15-30 wt. % reducing sugar” as a range, and the output generating element 116 may be configured to create output text indicating the range based on a step size. The step size may be either a default step size indicated by the system 100, be based on user input, or any combination thereof. In some cases, the step size indicated by the system 100 may be based on the content of the input text wherein the system 100 may be configured to identify patterns of step sizes based on what an average step size is within prior art associated with the subject matter of the content. In other scenarios, the system 100 may be configured to determine a step size based on a comparison of the subject matter of the input text to a given user's previously used step size in the same or substantially similar subject matter. The output of the output generation element 116 may, for example, include:
In certain embodiments, the composition comprises between 15 wt. % and 30 wt. % of the reducing sugar, such as between 15 wt. % and 20 wt. %, between 20 wt. % and 25 wt. %, or between 25 wt. % and 30 wt. %. In certain embodiments, the composition comprises at least 15 wt. % of the reducing sugar. In certain embodiments, the composition comprises less than 30 wt. % of the reducing sugar.

As illustrated in the example above, a step size of 5% is used to express the range in the input text. The output text may also include a statement related to a minimum or maximum identified based on the range, such as 15% and 30% in the example above. In some cases, the classifying may be configured to classify a Markush group within the input text. A Markush group may include a list of items. The output generating element 116 may be therefore configured to express the list of items in the Markush group. For example, a Markush group of “non-dairy ingredient chosen from corn starch, potato starch, cellulose, and combinations thereof.” In this case, the output text may include:
The non-dairy ingredient is chosen from corn starch, potato starch or cellulose. In some embodiments, the non-dairy ingredient is corn starch. In some embodiments, the non-dairy ingredient is potato starch. In some embodiments, the non-dairy ingredient is cellulose.

As illustrated in the example above, the classification of input text to include a Markush group may be used by the system 100 to generate associated output text. The location of the output text may be based on the location of the classified input text within the input text as a whole, the location of an associated field of the output template, a user input, or any combination thereof.

Portions assigning module 114 may be configured to assign the one or more identified portions to one or more associated fields of an output template based on the classification. For example, the portions assigning module 114 may be configured to assign a wherein clause to a location within the output text based on the classification of the wherein clause as further defining a concept associated with a classified claim element. In the resulting output text, a classified claim element may be expressed and followed by a wherein clause that further defines the classified claim element.

Output text generating module 116 may be configured to generate output text based on the assignment of the one or more identified portions to the one or more associated fields of the output template. The generation of output text includes identifying parts of speech and the classified one or more portions to translate the patent claim language to natural language prose associated with portions of a patent document other than the patent claim language. For example, in some cases translating the patent claim language to natural language prose may change a gerund form of a verb to an infinitive form of a verb. In some cases, this sort of verb conjugation may be based on the output template. The output template may contain an indication to recite a translated version of the input text using specific verb conjugations that are considered to be more appropriate for a given field within the template. For example, the input text may be a method claim containing gerund forms of verbs as steps of the method claim. The generation of the input text may include translating the gerund form of the method steps into infinitive form when discussing a system configured to carry out steps of the method via one or more processors, such as the processors 138 of system 100. For example, much of the text of this present document contains verb conjugations that is done automatically and based on a designated output template indicating where translations including the verb conjugations may be included in the output text based on a given context.

In some cases, the output text may be generated based on a correlation between the input text, the output template, and a parsing engine. As discussed above, the output text may include conjugations of verbs, for example, to discuss input text in a translated way that allows the input text to be discussed in reference to figures. The parsing engine may be configured to detect claim language in the input text, parse it for different classifications such as one or more of a preamble, one or more patent purpose clauses, a claim type identifier, one or more claim element clauses, and one or more definition clauses and the one or more definition clauses further define a concept associated with the claim element clauses. The parsing engine may then identify tags within the output template associated with one or more of the classifications. The tags may then be replaced by natural language processed language that is processed by the system 100. In some cases, the tags may be smart tags linked with specific natural language processing techniques and identified portions of the input text. The tags may be, in some cases, editable by the user in terms of where they exist in the output template, and therefore where they would generate natural language processed language in the output text based on the input text and a given natural language processing and/or generation technique associated with the tag. In some cases, the tags may be created by the user by enabling the user to define the natural language processing/generation technique that should be associated with a given tag, one or more portions of content within the input text to be associated with the tag, and the like. In this scenario, the user may dynamically adjust the output template and resulting output text to their liking, enabling the automation of generated output text to be further customized, enabling the user to reduce time spent on drafting the output text by hand, and reduce errors associated with drafting the output text by hand.

The natural language processed language may include verb conjugations that differ from the input language, but that are contextually appropriate for a given tag's location within the output template. In some cases, the verb conjugations may be selected by a user for any given tag location within the output template. In some cases, the processed language may also include language from the input text that is reorganized. For example, input language may recite “receiving input text” while the processed language in the output text may recite “input text receiving element.” In this way, language within the input text may be used to recite output text that is contextually relevant, provides literal support for the input text in the output text, and may also be synched with a figure. As an example, of the latter, the “input text receiving element” may be synched with a component in a figure generated by the system 100 and may be “input text receiving element 101” for example. In this way, the output text may include reference to figures generated by the system 100 providing synchronicity between the output text and the generated figures, consistency in terminology for a given element within the figures, and support for input text claim language in both the output text as well as the generated figures.

The output text may be generated using techniques including one or more of natural language generation, natural language processing, machine learning, artificial intelligence, and the like. In some cases, generating output text includes submitting the input text to natural language models, wherein the natural language models are based on patent document constraints. In some embodiments, the output text is generated based on a rules-based approach of natural language generation wherein rules specific to patent claim language are introduced to parse input text appropriately. The rules-based approach may be specific to patent claim language and may use formatting and contextually relevant language common to patent claim language to identify parts of an input patent claim within the input text. For example, a preamble may be identified by determining the first portion of the input text identifying the claim type, a purpose statement within the text, and the word “comprising” followed by a colon. The purpose statement may be, in some cases, a phrase indicating a general aim, goal, or concept of the input text. For example, a method claim may begin by stating “A method for doing something, comprising: . . . .” In this example, “doing something” is identified by the system 100 as the purpose statement, otherwise referred to herein as a “patent purpose.” By identifying the patent purpose, the conjugation of the verb “doing” may be changed depending on where within the output template a patent purpose is indicated to be used. For example, while the abstract may generally state “A method for doing something is disclosed,” the Detailed Description section may include a field related to a description of a system for carrying out the method, i.e., “A system configured to do something is disclosed.” In this way, categories of input text may be used to generate portions of the output text based on tags within the output template wherein, for example, the Abstract section of the output template may include the language “A method of . . . ” and a tag for inserting the patent purpose, based on detection of such in the input text.

In some cases, the output text may be configured to be generated by detecting patterns in the input text. The system 100 may be configured to use deep learning, machine learning, and the like trained on a large corpus of patent documents that are mined for statistical regularities. These regularities may be unknown to a user, but may be detectable by a system, such as system 100. The regularities may then be identified as a plurality of weighted connections between different nodes in a neural network associated with a pattern detection element of the system 100. This process may proceed with no, or little, human input. Based on the pattern detection as well as the weighted connections in the neural network, the pattern detection element may be configured to respond to text prompts associated with the output template.

In some cases, the system 100 may be configured to generate the input text based on training the pattern detection element on a corpus of invention disclosure documents. The weighted connections as well as pattern detection can then be used to respond to text prompts associated with an input text template. In this way, the input text may be generated by the system 100 automatically. In some cases, the system 100 may use hypernyms and hyponym analysis to determine one or more appropriately broad or narrow terms to be used in the generated input text, or claim language, as opposed to one or more terms that are overbroad or overly narrow in the invention disclosure document.

As discussed herein, the input text may include claim language. As described herein, claim language is language that is structured, formatted, word-specific, and term-specific. More specifically, claim language may include one or more words having legal meaning in a given jurisdiction. A basic example of claim language includes the word “comprising.” While “comprising” may be used in the output text, it is not interpreted to have the same meaning as it does in the input text or in patent claims. In some circumstances, the output text may translate the word “comprising” into the word “including.” Therefore, in some aspects, the system 100 may be configured to translate patent claim language into natural language prose that may or may not include the same words.

In some cases, the output text may be generated dynamically as a user inputs the input text, selects fields, or any combination thereof. In this scenario, the user may be able to see how changes in the input text affect changes in the output text. Therefore, the user may be able to modify the output text by way of changes to the input text, selected fields, and the like before committing the output text to a downloadable document. This may decrease the amount of times the user needs to reinsert their input text into the tool, thereby reducing the amount of time associated with generating the output text. In some cases, this may be referred to a live preview of the output text.

In some cases, changes in the input text may dynamically change a live preview of the output figures. In this scenario, a user can visualize how the figures will look before they commit to a downloadable version.

Further, in some cases, the system 100 may be configured with machine-readable instructions stored on the memory 140 that when executed by the processor 138 cause the system 100 to receive the input text, receive a selection of one or more portions of the input text to be mapped to a location in a figure, and map the selected one or more portions to the location in the figure. In this scenario, the figures may be custom figures that are invention specific and related to the input text. In this way, the user may be able to map the selected portions of the input text to components and locations of related components in a custom figure. In some cases, the figure may be automatically selected based on parsing the input text to determine a context of the technology described in the input text. In this case, the system 100 may employ a search engine, machine learning, and the like to find figures that may be suggested to the user as figures that can be used to map portions of the input text to locations in a selected one or more figure from the suggested figures.

When mapping one or more portions of the input text to a figure by receiving a user selection of the one or more portions and an indication of the associated location to map the selected one or more portions to, the output text may be generated based on that mapping. For example, the output text may refer to mappings of the selected one or more portions to locations within a given figure, and may then recite context of the selected one or more portions in reference to the figure based on the context of the selected one or more portions within the input text. For example, the user may select “a widget comprising a top side and a bottom side” as being mapped to a given location of an invention specific figure. In that scenario, the output text may describe “a widget 102 including a top side and a bottom side.” In this way, once the user maps portions of the input text to invention specific figures, the auto-generated draft of a patent application may be generated by the output text of the system 100 based on references to the mapping as well as the input text, the output template, and relative positions of the mapping within the input text and the output template.

By using the system 100 to auto-generate a draft of a patent application, the system 100 will reduce the number of hours that may be otherwise associated with drafting a patent application. As input text including claim language includes many words and phrases that are repeated throughout the application, the output text generated by the system 100 can reduce time spent, reduce errors that may otherwise occur if done manually, and increase the efficiency of use of the computing device as well as use of word processing software. This efficiency is further increased as the system 100 will generate figures associated with the output text, as discussed below.

Figures generating module 118 may be configured to generate one or more figures associated with the output text. In some cases, generating the one or more figures includes detecting one or more claim element clauses from the input text, generating one or more visual elements based on one or more detected claim element clauses within the one or more identified portions of the input text, wherein each of the one or more visual elements generated is associated with a different claim element clause, generating figure-specific output text based on the detected one or more claim element clauses, and inserting the figure-specific output text associated with the detected one or more claim element clauses in one or more associated visual elements from among the one or more generated visual elements. In some cases, figures generating module 118 may be configured to number the one or more generated visual elements based on a position of each of the associated claim element clauses within the input text.

The figures may be generated to be used in conjunction with the output text to provide literal support for the input text in both the output text as well as the figures. For example, FIG. 1 illustrates a figure generated by the system 100 as well as the modules including input text receiving module 108, portions identifying module 110, portions classifying module 112, portions assigning module 114, output text generating module 116, figures generating module 118, elements numbering module 120, word mapping module 122, element numbering module 124, selection receiving module 126, input text translating module 128, input text generating module 130, input text generating module 132, claims generating module 134, and/or other modules. The generation of the figures is configured to be done in sync with the related text in the output text.

To aid in syncing the output text with the generated figures, numbering will be added to the figures as well as the output text by, for example, the elements numbering module 120. Elements numbering module 120 may be configured to number the one or more generated visual elements based on a position of each of the associated claim element clauses within the input text. For example, the elements may be numbered based on the output template indicating a system diagram, such as the system 100, is to be discussed as a first figure. Other numberings are possible and are indicated based on changes made by the user based on a desired result, or may be in some cases based on a determination made by the system 100 that the numbering may be better suited to start a given point based on the subject matter of the input text, a user preference associated with historic use, a determined classification of the invention at a jurisdictional patent office, such as the United States Patent and Trademark Office, and the like.

Word mapping module 122 may be configured to map a word or phrase within the input text to an element within a figure based on user input. In some cases, generating output text is based on the mapping and number the element based on a position of the word or phrase within the input text and in comparison, to subsequent and previously mapped words or phrases. For example, word mapping module 122 may be configured to identify one or more modules, such as input text receiving module 108, portions identifying module 110, portions classifying module 112, portions assigning module 114, output text generating module 116, figures generating module 118, elements numbering module 120, word mapping module 122, element numbering module 124, selection receiving module 126, input text translating module 128, input text generating module 130, input text generating module 132, claims generating module 134, and/or other modules. These modules are mapped based on the wording of the input claims wherein, in some cases, the mapping may identify the verb of a method step and the object of the verb to generate an “object verb module ###” with a corresponding number based on a position of the identified verb within the input text, and based on the position of an associated field within the output template.

Element numbering module 124 may be configured to number the element based on a position of the word or phrase within the input text and in comparison, to subsequent and previously mapped words or phrases. As discussed above in regard to the object verb module ###, a number may be provided for a given element within the figures based on the position of the word or phrase within the input text and/or in comparison to subsequently or previously mapped words or phrases in conjunction with an associated field of the output template.

Selection receiving module 126 may be configured to receive a selection of one or more claim types. Selection of the one or more claim types may provide an indication for the system 100 to mirror the claims into additional claim types. For example, the input text may include a method, and mirrored claim types may include an apparatus, a system, such as system 100, a computer-readable medium, and the like.

Input text translating module 128 may be configured to translate the input text into one or more selected claim types. The selection of claim types may be based on either user input, a selection made by the system 100 based on the content of the input text to classify the technology and appropriate claim types for the technology, or any combination thereof.

Input text generating module 130 may be configured to generate the input text based on technical input documents describing a technical concept. For example, the input text may, in some cases be itself generated by the system 100 by parsing a technical input document such as an invention disclosure. An invention disclosure may include technical concepts of an invention that may be parsed and used to generate claim language to be used to generate output text. The input text generating module 130 may be configured to generate the input text by the input text generating module 132 which may be configured to generate the input text by replacing the associated one or more words of the technical input document with the one or more identified hypernyms. In some cases, either 130, 132 or both may be used to generate input claims based on a given technology subject matter, previous inventions associated with an invention disclosure created by the inventor of the invention disclosure, prior art associated with the disclosure, and the like. In some cases, the input text can be generated using natural language generation techniques wherein an invention disclosure is parsed by the system 100 and categorized based on content. For example, the invention disclosure may include sections characterizing the prior art, a shorter summary of the invention, differences between the prior art and the present invention, figures, a detailed description that is longer than the shorter summary, implementation details, and the like. The system 100 may therefore use these categorizations to implement the input text generation or claim generation. In some cases, the claim generation may be done by referencing a corpus including pairs of invention disclosures and related claims. In this manner, the system 100 may be configured to determine similarities among the present invention disclosure and one or more pairs of documents within the corpus. By determining similarities, the system 100 maybe configured to generate claim language by way of natural language generation based on the determined similarities with the one or more pairs in the corpus.

In some cases, the corpus of patent documents may include triplet combinations of documents including an invention disclosure, a resulting patent application including claims, and a resulting allowed and granted patent. The triplet combinations may be used to measure success of claims within the resulting patent application against the claims in the resulting granted patent. For example, the system 100 may be configured to identify whether the claims in the patent application differ from the claims in the granted patent. The system 100 may detect how many additional words were used in the granted patent claims versus the patent application claims, whether the additional words were found within the specification of either the granted patent, the patent application, or both, and determine a score for whether the patent claims in the patent application were appropriately broad or narrow based on the comparison of those claims with the granted patent claims as well as the details in the invention disclosure document. This scoring may be then used to determine appropriate breadth in hypernyms or hyponyms in generating the input text, or claim language based on an associated invention disclosure.

Claims generating module 134 may be configured to generate one or more mirrored claims from the input text. Based on the results of the input text translation module 128, input text containing one type of claim may be mirrored into another type of claim. The claims that are generated may be based on a selection received from user input.

In some embodiments, the system 100 may be further configured to automatically create portions of an output template based on a user's previous work. For example, a given user may upload a recently filed patent application to use as input for creation of a template. The system 100 may be configured to detect portions of the uploaded document that are generic, or not directly related to the claims of the document other than peripherally. For example, the uploaded document may contain various descriptions that can be identified as useful in a given technology area, such as software, hardware, electrical circuits, etc., and may be used across a technology area for more than any one given application, such as in the context of the uploaded document representing a specific invention as well as content that can be used in similar applications. The system 100 may also be configured to identify the owner of the uploaded patent document, the inventor(s) of the uploaded patent document, and the like. The system 100 may therefore detect these portions of the uploaded document, identify positions of these portions within the document, whether they are associated with any given figure of the uploaded document, whether they recite specific claim language of the uploaded document, and the like. Based on the detected portions, the output template may be modified to include the detected portions. In some cases, the detected portions may be used to modify the output template at a selected location based on the identified position of the detected portions within the uploaded document. In some cases, the output template may be modified by including detected portions with reference to a given figure based on the detection of whether the detected portions are associated with a similar type of figure in the uploaded document. A figure may be determined to be similar type of figure based on whether language appearing in the detected portions is similar to language appearing in the given figure associated with the output template, similar language appearing in text associated with the given figure in the output template text, or any combination thereof. The concept of similarity may, in some cases, be based on a semantic threshold indicating a similarity amount of terms in each document, figure, etc., can be identified as being the same. In some embodiments, similarity in figures may be determined by way of computer vision wherein the uploaded document may contain figures. The figures of the uploaded document may be analyzed by the system 100 by way of techniques, such as computer vision, and/or including techniques configured to identify components of a given figure, relational spacing between one or more components, language associated with one or more components, and the like.

In some cases, detection of portions of the uploaded document by the system 100 may also include detection of formatting of the uploaded document that can be identified and used by the system 100 to modify associated characteristics of the output template, such as margins, text style, spacing, headings arrangement, and the like. In some cases, the system 100 may be further configured to match the uploaded document with a corpus of other examples of patent applications based on machine learning wherein the text and figures of the uploaded document may be used to develop categories associated with the text such as technology area, style, boilerplate text, and the like, such that the system 100 may use any resulting matched examples to augment the output template based on text, figures, and the like that appear in the corpus of other examples. The system 100 may also be configured to identify the owner of the uploaded patent document, the inventor(s) of the uploaded patent document, and the like. In some cases, these categories such as assignment information, inventors, priority date, may be used to determine a match. The match may then be used to further augment the output template. In some cases, the output template may be modified differently based on the age of the uploaded document. If, for example, the uploaded document is more than one or two years old, the system 100 may be configured to use more recent matches within the corpus to determine language that may be more prescient, legally updated, technically updated, and the like, than language that appears in the uploaded document, while still preserving a style of the document as well as location and general context of the uploaded document for use in augmenting the output template.

In some cases, the one or more computing platforms 102, may be communicatively coupled to the remote platform(s) 104. In some cases, the communicative coupling may include communicative coupling through a networked environment 136. The networked environment 136 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms 102 and remote platform(s) 104 may be operatively linked via some other communication coupling. The one or more one or more computing platforms 102 may be configured to communicate with the networked environment 136 via wireless or wired connections. In addition, in an embodiment, the one or more computing platforms 102 may be configured to communicate directly with each other via wireless or wired connections. Examples of one or more computing platforms 102 may include, but is not limited to, smartphones, wearable devices, tablets, laptop computers, desktop computers, Internet of Things (IoT) device, or other mobile or stationary devices. In an embodiment, system 100 may also include one or more hosts or servers, such as the one or more remote platforms 104 connected to the networked environment 136 through wireless or wired connections. According to one embodiment, remote platforms 104 may be implemented in or function as base stations (which may also be referred to as Node Bs or evolved Node Bs (eNBs)). In other embodiments, remote platforms 104 may include web servers, mail servers, application servers, etc. According to certain embodiments, remote platforms 104 may be standalone servers, networked servers, or an array of servers.

The one or more computing platforms 102 may include one or more processors 138 for processing information and executing instructions or operations. One or more processors 138 may be any type of general or specific purpose processor. In some cases, multiple processors 138 may be utilized according to other embodiments. In fact, the one or more processors 138 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 138 may be remote from the one or more computing platforms 102, such as disposed within a remote platform like the one or more remote platforms 138 of FIG. 1.

The one or more processors 138 may perform functions associated with the operation of apparatus 10 which may include, for example, precoding of antenna gain/phase parameters, encoding and decoding of individual bits forming a communication message, formatting of information, and overall control of the one or more computing platforms 102, including processes related to management of communication resources.

The one or more computing platforms 102 may further include or be coupled to a memory 140 (internal or external), which may be coupled to one or more processors 138, for storing information and instructions that may be executed by one or more processors 138. Memory 140 may be one or more memories and of any type suitable to the local application environment and may be implemented using any suitable volatile or nonvolatile data storage technology such as a semiconductor-based memory device, a magnetic memory device and system, an optical memory device and system, fixed memory, and removable memory. For example, memory 140 can consist of any combination of random access memory (RAM), read only memory (ROM), static storage such as a magnetic or optical disk, hard disk drive (HDD), or any other type of non-transitory machine or computer readable media. The instructions stored in memory 140 may include program instructions or computer program code that, when executed by one or more processors 138, enable the one or more computing platforms 102 to perform tasks as described herein.

In some embodiments, one or more computing platforms 102 may also include or be coupled to one or more antennas (not shown) for transmitting and receiving signals and/or data to and from one or more computing platforms 102. The one or more antennas may be configured to communicate via, for example, a plurality of radio interfaces that may be coupled to the one or more antennas. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

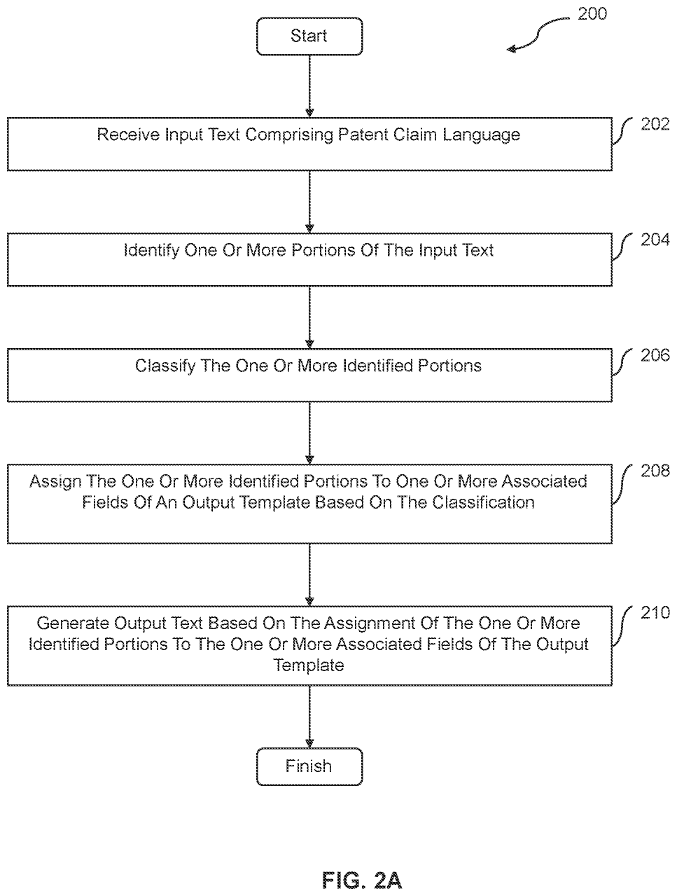

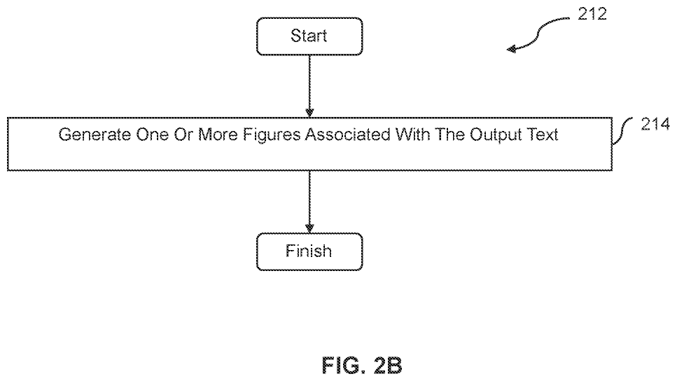

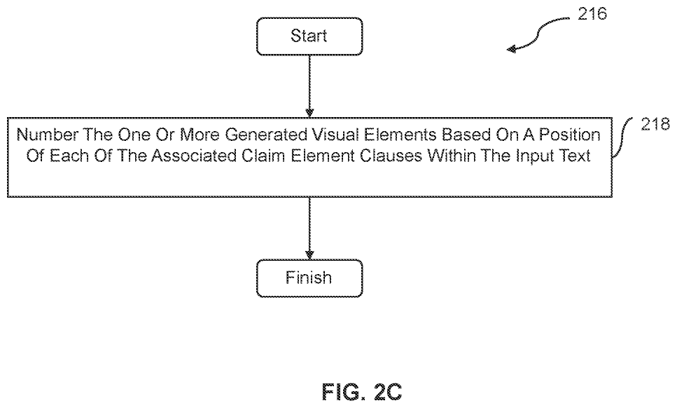

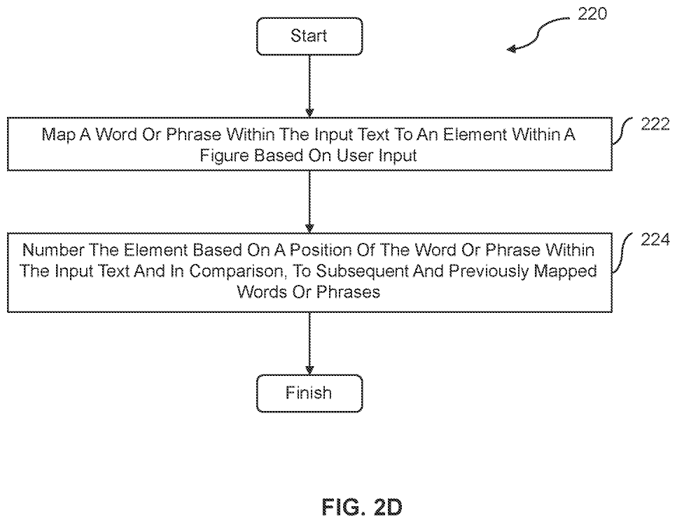

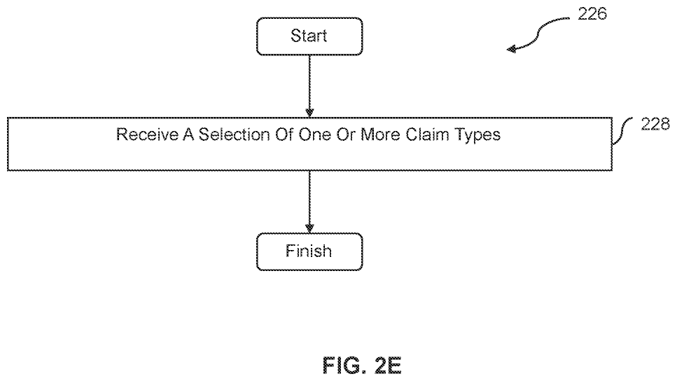

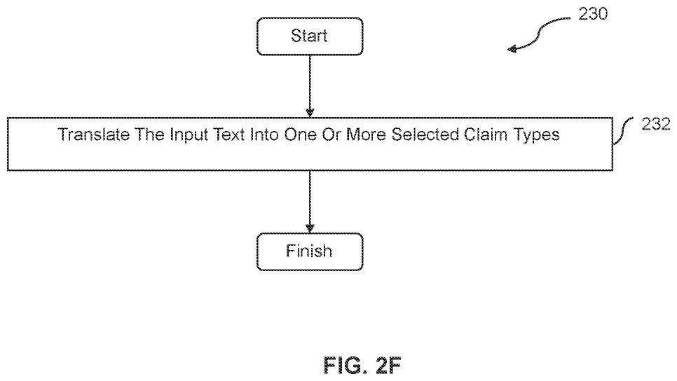

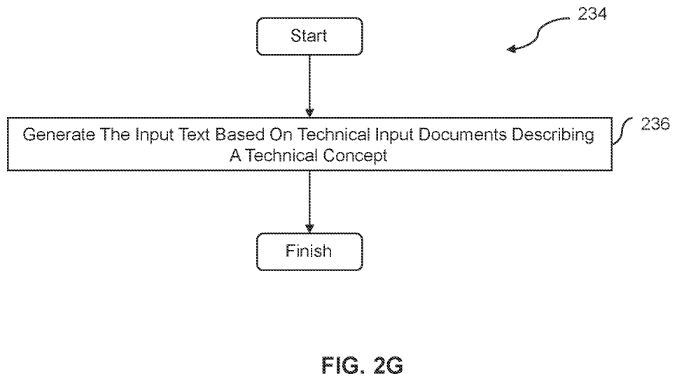

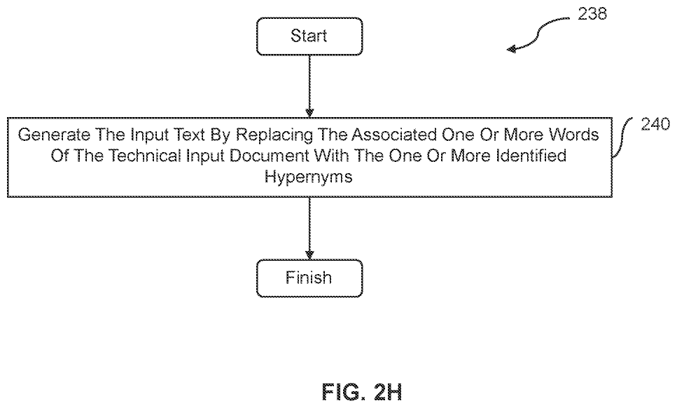

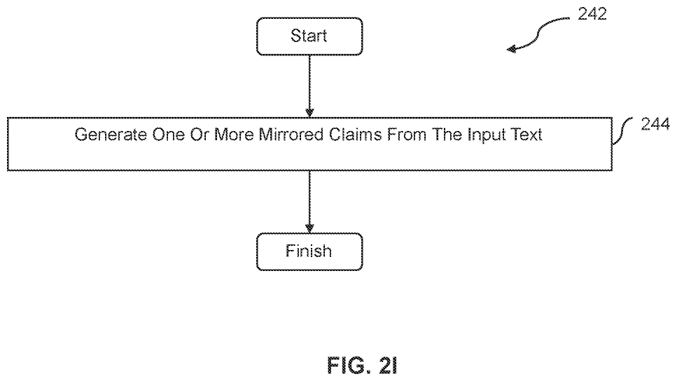

FIGS. 2A, 2B, 2C, 2D, 2E, 2F, 2G, 2H and/or 2I illustrate an example flow diagram of a method 200, according to one embodiment. FIG. 2A illustrates method 200, in accordance with one or more embodiments. The method 200 may include receiving input text including patent claim language at block 202. The method 200 may include identifying one or more portions of the input text at block 204. The method 200 may include classifying the one or more identified portions at block 206. The method 200 may include assigning the one or more identified portions to one or more associated fields of an output template based on the classification at block 208. The method 200 may include generating output text based on the assignment of the one or more identified portions to the one or more associated fields of the output template at block 210, the generation of output text includes identifying parts of speech and the classified one or more portions to translate the patent claim language to natural language prose associated with portions of a patent document other than the patent claim language.

In FIG. 2B, the method 200 may be continued at 212, and may further include generating one or more figures associated with the output text at block 214.

In FIG. 2C, the method 200 may be continued at 216, and may further include numbering the one or more generated visual elements based on a position of each of the associated claim element clauses within the input text at block 218.

In FIG. 2D, the method 200 may be continued at 220, and may further include mapping a word or phrase within the input text to an element within a figure based on user input at block 222. The method 200 continued at 220 may also further include numbering the element based on a position of the word or phrase within the input text and in comparison, to subsequent and previously mapped words or phrases at block 224.

In FIG. 2E, the method 200 may be continued at 226, and may further include receiving a selection of one or more claim types at block 228.

In FIG. 2F, the method 200 may be continued at 230, and may further include translating the input text into one or more selected claim types at block 232.

In FIG. 2G, the method 200 may be continued at 234, and may further include generating the input text based on technical input documents describing a technical concept at block 236.

In FIG. 2H, the method 200 may be continued at 238, and may further include generating the input text by replacing the associated one or more words of the technical input document with the one or more identified hypernyms at block 240.

In FIG. 2I, the method 200 may be continued at 242, and may further include generating one or more mirrored claims from the input text at block 244.

In some cases, the method 200 may be performed by one or more hardware processors, such as the processors 138 of FIG. 1, configured by machine-readable instructions, such as the machine readable instructions 106 of FIG. 1. In this aspect, the method 200 may be configured to be implemented by the modules, such as the modules 108, 110, 112, 114, 116, 118, 120, 122, 124, 126, 128, 130, 132 and/or 134 discussed above in FIG. 1.

What is claimed is:

1. An apparatus for generating patent language, comprising:
at least one memory storing computer program instructions; and
at least one processor configured to execute the computer program instructions to cause the apparatus at least to:
receive input text comprising patent claim language;
identify one or more portions of the input text;
classify the one or more identified portions;
assign the one or more identified portions to one or more associated fields of an output template based on the classification; and
generate output text based on the assignment of the one or more identified portions to the one or more associated fields of the output template, wherein the generation of output text comprises identifying parts of speech and the classified one or more identified portions to translate the patent claim language to natural language prose associated with portions of a patent document other than the patent claim language.

2. The apparatus of claim 1, wherein the classifying is based on identifying one or more of a preamble, one or more patent purpose clauses, a claim type identifier, one or more claim element clauses, and one or more definition clauses.

3. The apparatus of claim 2, wherein the one or more definition clauses further define a concept associated with the claim element clauses.

4. The apparatus of claim 1, wherein the at least one memory and the computer program code are further configured to, with the processor, cause the apparatus to generate one or more figures associated with the output text.

5. The apparatus of claim 4, wherein generating the one or more figures comprises, detecting one or more claim element clauses from the input text, generating one or more visual elements based on one or more detected claim element clauses within the one or more identified portions of the input text, wherein each of the one or more visual elements generated is associated with a different claim element clause, generating figure-specific output text based on the detected one or more claim element clauses, and inserting the figure-specific output text associated with the detected one or more claim element clauses in one or more associated visual elements from among the one or more generated visual elements.

6. The apparatus of claim 4, wherein the at least one memory and the computer program code are further configured to, with the processor, cause the apparatus to number the one or more generated visual elements based on a position of each of the associated claim element clauses within the input text.

7. The apparatus of claim 1, wherein generating output text comprises submitting the input text to natural language models, wherein the natural language models are based on patent document constraints.

8. The apparatus of claim 1, wherein the at least one memory and the computer program code are further configured to, with the processor, cause the apparatus to map a word or phrase within the input text to an element within a figure based on user input, wherein generating output text is based on the mapping; and number the element based on a position of the word or phrase within the input text and in comparison, to subsequent and previously mapped words or phrases.

9. The apparatus of claim 1, wherein the at least one memory and the computer program code are further configured to, with the processor, cause the apparatus to receive a selection of one or more claim types.

10. The apparatus of claim 9, wherein the at least one memory and the computer program code are further configured to, with the processor, cause the apparatus to translate the input text into one or more selected claim types.

11. The apparatus of claim 1, wherein the output text is dynamically generated while the input text is received.

12. The apparatus of claim 1, wherein the at least one memory and the computer program code are further configured to, with the processor, cause the apparatus to generate the input text based on technical input documents describing a technical concept.

13. The apparatus of claim 12, wherein the input text is generated by identifying one or more hypernyms or hyponyms associated with one or more words of the technical input document, wherein the at least one memory and the computer program code are further configured to, with the processor, cause the apparatus to generate the input text by replacing the associated one or more words of the technical input document with the one or more identified hypernyms.

14. The apparatus of claim 1, wherein classifying comprises identifying a numerical range within the input text, and wherein generating the output comprises expressing the numerical range as a plurality of ranges having a smaller scale compared to the identified numerical range based on step size.

15. The apparatus of claim 1, wherein the at least one memory and the computer program code are further configured to, with the processor, cause the apparatus to generate one or more mirrored claims from the input text.

16. A method of generating patent language, comprising:
receiving input text comprising patent claim language;
identifying one or more portions of the input text;
classifying the one or more identified portions;
assigning the one or more identified portions to one or more associated fields of an output template based on the classification;
generating output text based on the assignment of the one or more identified portions to the one or more associated fields of the output template, wherein the generation of output text comprises identifying parts of speech and the classified one or more portions to translate the patent claim language to natural language prose associated with portions of a patent document other than the patent claim language.

17. The method of claim 16, wherein the classifying is based on identifying one or more of a preamble, one or more patent purpose clauses, a claim type identifier, one or more claim element clauses, and one or more definition clauses.

18. The method of claim 17, wherein the one or more definition clauses further define a concept associated with the claim element clauses.

19. The method of claim 16, further comprising generating one or more figures associated with the output text.

20. The method of claim 19, wherein generating the one or more figures comprises, detecting one or more claim element clauses from the input text, generating one or more visual elements based on one or more detected claim element clauses within the one or more identified portions of the input text, wherein each of the one or more visual elements generated is associated with a different claim element clause, generating figure-specific output text based on the detected one or more claim element clauses, and inserting the figure-specific output text associated with the detected one or more claim element clauses in one or more associated visual elements from among the one or more generated visual elements.
